(19) United States
(12) Patent Application Publication
(10) Pub. No.: US 2005/0199298 A1
(43) Pub. Date: Sep. 15, 2005

(54) Contiguously formed valve cage with a multidirectional fluid path

(75) Inventor: Ronald L. Farrington, Nevada, IA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FISHER CONTROLS INTERNATIONAL, LLC, St. Louis, MO (US)

(21) Appl. No.: 10/797,535

(22) Filed: Mar. 10, 2004

(51) Int. Cl. F16K 47/08

(52) U.S. Cl. 137/625.37

(57) ABSTRACT

A control valve is disclosed and which comprises a valve body having an inlet, an outlet, and a flow passage extending between the inlet and the outlet, a seat ring mounted in the flow passage, a valve plug shiftably mounted within the valve body for movement between a first position and a second position, the valve plug cooperating with the seat ring to close the flow passage when the valve plug is in the first position and a valve plug actuator for moving the valve plug between the first position and the second position. A valve cage is mounted to the seat ring and comprises a contiguously formed sidewall having an inner surface and an outer surface and surrounding a bore sized to receive the valve plug, a plurality of first apertures defined in the inner surface of the sidewall, a plurality of second apertures defined in the outer surface of the sidewall, and a plurality of multidirectional fluid passages, each one of the multidirectional fluid passages extending between one of the first apertures and at least one the second apertures and wherein at least one of the multidirectional fluid passages is disposed in the flow passage when the valve plug is in the second position.

### TECHNICAL FIELD

This invention relates in general to a valve cage for use in a control valve, and more specifically, to a valve cage being contiguously formed and having a multidirectional fluid path.

### BACKGROUND

Valves are used in many industries to aid the flow of liquids and gases. In some instances, it may be necessary to reduce the pressure of the fluid. Adjustable flow restriction devices, such as flow control valves and fluid regulators, and other fixed fluid restriction devices, such as diffusers, silencers, and other back pressure devices, sometimes are used for this task.

It is known that pressurized fluid contains stored mechanical potential energy. Reducing the pressure releases this energy. The energy manifests itself as the kinetic energy of the fluid in both the bulk motion of the fluid and its random turbulent motion. Pressure and velocity fluctuations that are sometimes associated with the turbulent fluid motion act upon the structural elements of the piping system, causing vibration. Vibration may lead to fatigue failure of pressure retaining components or other types of wear, degradation of performance, or failure of attached instruments.

To combat vibration and noise, control valves typically have utilized various fluid pressure reduction devices, such as aerodynamic noise trim designs which reduce pressure differentials and turbulence, reducing the generated noise. A common technique to reduce the pressure is to attempt to create a complex flow patterns within the device as opposed to a linear flow pattern. Due to the complex flow patterns typically utilized to reduce acoustic noise, pressure reduction devices typically require specialized manufacturing. For example, some manufacturing techniques include providing annular disks of many inner diameter/outer diameter combinations which can be cut from a common sheet and stacked to the desirable height.

Despite various control valve designs and manufacturing techniques, there is a continued need for improved control valve designs.

### BRIEF DESCRIPTION OF THE DRAWINGS

The present invention is best understood from the detailed description which follows, taken in conjunction with the accompanying drawings, in which:

FIG. 1 is a cross sectional side view illustrating a fluid control valve containing a valve cage having a multidirectional fluid path in accordance with one embodiment of the present invention;

FIG. 2A is a front perspective view illustrating one embodiment of the valve cage of FIG. 1;

FIG. 2B is a cross sectional plan view taken along two planes and illustrating one embodiment of the valve cage of FIG. 1;

FIG. 3 is a fragmented perspective view illustrating one embodiment of the valve cage of FIG. 1 with a schematic representation of a fluid flow path therethrough;

FIG. 4 is a cross sectional side view illustrating one embodiment of the valve cage of FIG. 1 with a schematic representation of a fluid flow path therethrough;

FIG. 5 is a fragmented cross sectional plan view illustrating one embodiment of the valve cage of FIG. 1 with a schematic representation of a fluid flow path therethrough;

FIG. 6 is a fragmented cross sectional plan view illustrating another embodiment of the valve cage of FIG. 1 with a schematic representation of a tortuous fluid flow path therethrough;

FIG. 7 illustrates schematically a selective laser sintering printing apparatus in accordance with one embodiment of the present invention; and

FIG. 8 illustrates in a flowchart, a printing routine that may be performed by the selective laser sintering printing apparatus of FIG. 7.

### DETAILED DESCRIPTION

The following embodiments described herein are not intended to be exhaustive or to limit the scope of the invention to the precise forms disclosed. Instead, the following embodiments have been described in order to best explain the principles of the invention and to enable others of ordinary skill in the art to follow its teachings.

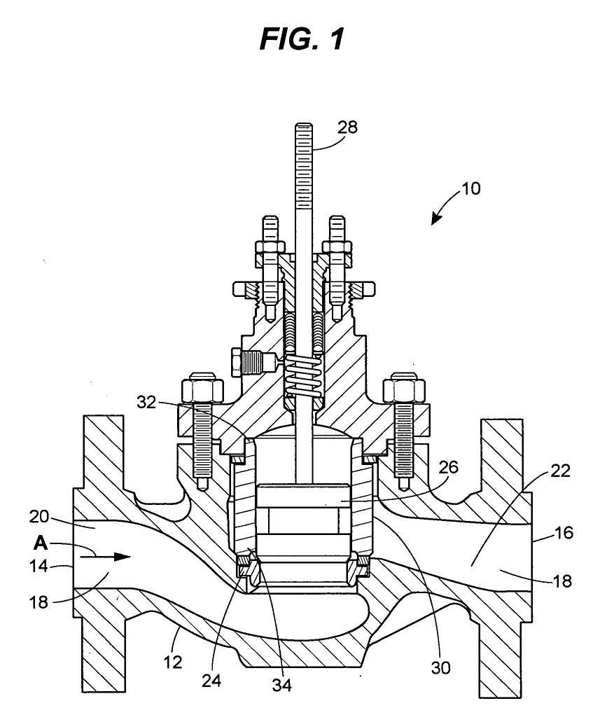

Referring now to FIG. 1 of the drawings, a control valve assembled in accordance with the teachings of an embodiment of the present invention is generally referred to by the reference numeral 10. The control valve 10 includes a valve body 12 having an inlet end 14 and an outlet end 16. A passage 18 is defined through the body 12 and includes an inlet passage 20 and an outlet passage 22.

A seat ring 24 is mounted within the passage 18 and a valve plug 26 is shiftably mounted within the valve body for movement between a first position (not shown) and a second position as shown in FIG. 1. The valve plug 26 cooperates with the seat ring 24 to close the passage 18 when the valve plug is in the first position, effectively stopping fluid flow (indicated by an arrow A in FIG. 1). The body 12 of the control valve 10 further includes an actuator (not shown) operably connected to the valve plug 26 by a valve plug stem 28, for shiftably moving the valve plug 28 between the first and second positions.

A generally cylindrical valve cage 30 is disposed within the passage 18 of the body 12 and is mounted to the seat ring 24 such that, as will be described below, fluid flow through the passage 18 travels through the valve cage 30 when the valve plug is shifted away from the first position. It will be appreciated that the valve cage 30 is shown in cross section when viewing FIG. 1.

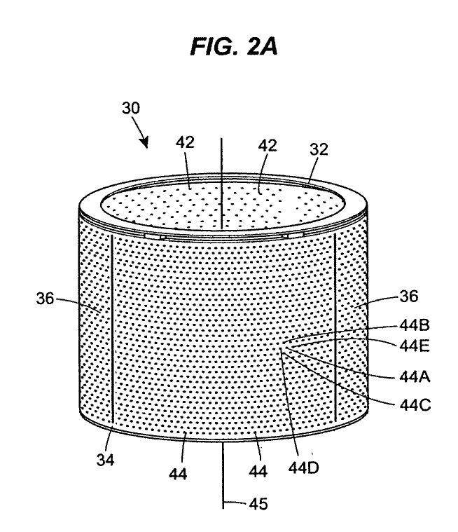

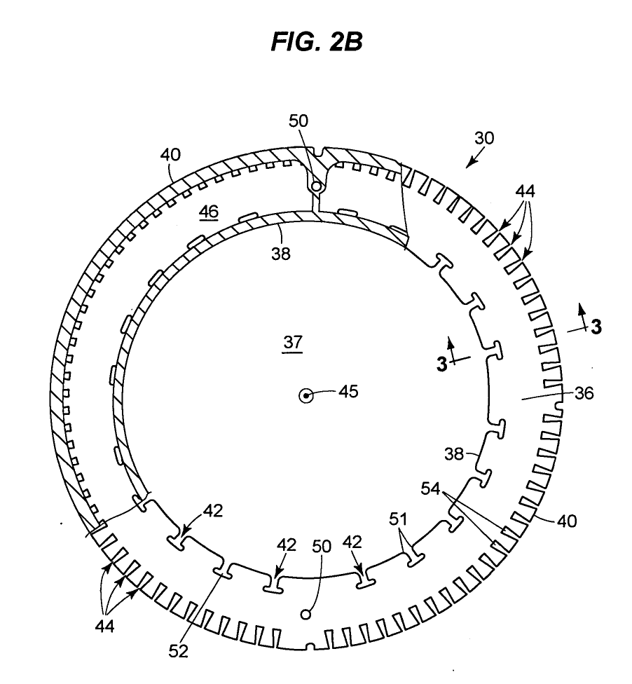

As best shown in FIGS. 2A, 2B, and 3, the valve cage 30 includes a pair of ends 32, 34, and an interconnecting sidewall 36 enclosing an interior chamber 37 having a central axis 45. The sidewall 36 is contiguously formed out of a single piece of material. In other words, the sidewall 36 is a unitarily formed piece of material with any bores, channels, passages, apertures, or the like, removed from or formed within the sidewall 36, as will be discussed in greater detail below.

The sidewall 36 includes an inner surface 38 and an outer surface 40. In the disclosed example, the valve cage 30 is formed in a generally cylindrical shape and the interior chamber 37 is sized to receive the valve plug 26 and allow the valve plug 26 to move between the first and second positions described above. At least one of the ends 32, 34 are sized to be mounted on the seat ring 24 and the seal between the seat ring 24 and the valve cage 30 may be an O-ring, gasket, or other suitable seal of the type commonly employed in the art.

In the illustrated embodiment, there is a plurality of mounting holes 50 on the valve cage 30. Each of the mounting holes 50 extends through the valve cage 30 and is adapted to accommodate a mounting bolt 48 (see FIG. 1), mounting pin, or other similar device to mount the valve cage 30 to the seat ring 24. As can be seen in FIG. 2B, the mounting holes 50 in the valve cage 30 do not interfere with fluid flow through the valve cage 30.

The valve cage 30 includes a plurality of inlet apertures 42 arranged on the inner surface 38 of the valve cage 30, axially, radially, and circumferentially spaced with respect to the central axis 45 of the valve cage 30 in any pattern, including the illustrated symmetrical pattern. For example, as shown in FIG. 3, a first inlet aperture 42A may be axially spaced from a second inlet aperture 42B and a third inlet aperture 42C. Similarly, the first inlet aperture 42A may be circumferentially spaced from a fourth inlet aperture 42D and a fifth inlet aperture 42E. Finally, each of the inlets 42A-42E are radially located on the same diameter with respect to the central axis 45.

The valve cage 30 also includes a plurality of outlet apertures 44 arranged on the outer surface 40 of the valve cage 30, axially, radially, and circumferentially spaced with respect to the central axis 45 of the valve cage 30 in any pattern, including the illustrated symmetrical pattern. For example, as shown in FIG. 2A, a first outlet aperture 44A may be axially spaced from a second outlet aperture 44B, and a third outlet aperture 44C. Similarly, the first outlet aperture 44A may be circumferentially spaced from a fourth outlet aperture 44D and a fifth outlet aperture 44E. Additionally, each of the outlets 44A-44E are radially located on the same diameter with respect to the central axis 45.

It will be understood that, according to the disclosed embodiment, these apertures 42, 44 will form at least a portion of the cross-sectional area of the control valve passage 18 when the valve plug is removed from sealable engagement with the seat ring 24. Additionally, it will be further appreciated that in the illustrated embodiment, the inlet and outlet apertures 42, 44 are generally symmetrically arranged axially, radially and circumferentially with respect to the central axis 45 of the valve cage 30. Other aperture arrangements may be utilized.

One of a plurality of fluid paths extends between each one of the inlet apertures 42, and at least one of the outlets 44 so as to provide a plurality of multidirectional passages 46 between the inner surface 38 of the sidewall 36 and the outer surface 40 of the sidewall 36.

Each one of the plurality of passages 46 extends between each one of the inlet apertures 42 and at least one of the outlets 44. As best shown in FIGS. 2B, and 3, in one example, the passages are multidirectional passages formed by an axially offset plenum 48, extending between the apertures 42, 44. For instance, in the illustrated embodiment, the plenum 48 is axially offset from the plane of the inlet aperture 42 and the outlet aperture 44 (e.g., either below or above the plane of the apertures 42, 44) to form a multidirectional, and in this case multi-planar fluid passage.

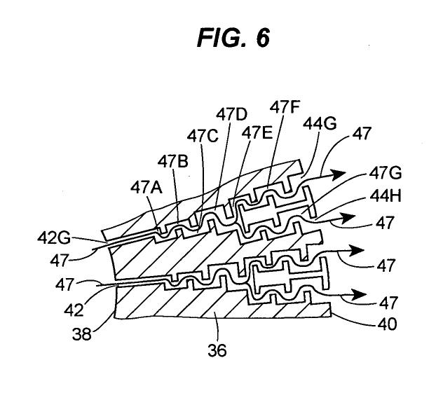

It will be appreciated that in other embodiments, for example, see FIG. 6, the fluid passage may be defined by one or more bends of turns defining a tortuous path 47. For example, the tortuous path 47 may include one or more radially and circumferentially offset bends to form a non-linear path that forces a change in direction of the fluid as it passes through the sidewall 36. The tortuous path 47 may be adapted to combine multiple inlet apertures 42 and/or multiple outlet apertures 44 thereby intersecting multiple fluid flow paths. For instance, as shown in FIG. 6, the tortuous path 47 combines an inlet aperture 42G with multiple outlet apertures 44G and 44H.

In the illustrated embodiment of FIGS. 2B, 3, and 5, each of the inlet apertures 42 is formed with corner radii 50 which tends to prevent the fluid flow from separating from the outer surface 38 of the valve cage 30 when passing through the inlet aperture 42. Also, the cross sectional area of the inlet aperture 42 may be tapered to diverge radially outwardly (e.g., enlarged), providing the fluid passage 46 with an expansion zone 52.

Still further, in the disclosed embodiment, each of the outlet apertures 44 is formed with a decreasing cross sectional area for each of the fluid outlet apertures 44. For example, the cross sectional area of the outlet aperture 44 is tapered to converge radially inwardly (e.g., narrowed), to provide the fluid passage 46 with a contraction zone 54.

It will be appreciated that any number of expansion zones 52 and contraction zones 54 may be provided in the fluid passages 46. Similarly, the transition between each zone 52, 54 may be abrupt, linear, smooth, gradual, or of any other similar construction.

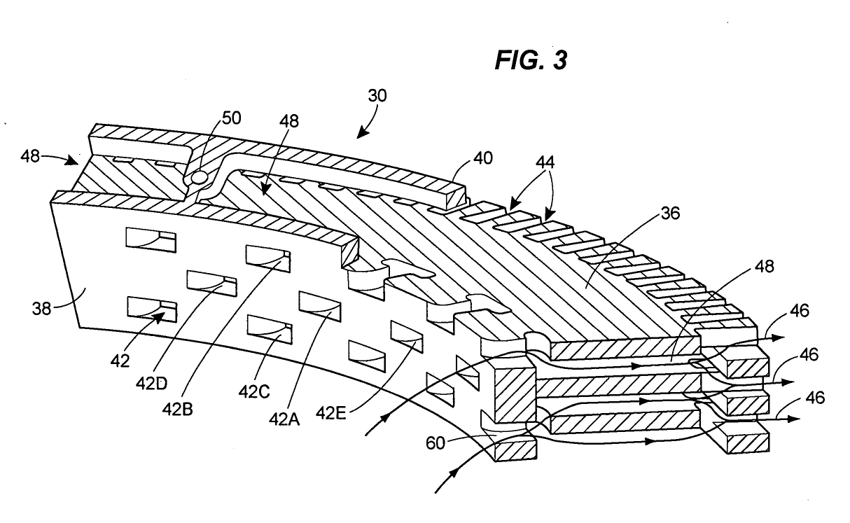

Referring now to FIGS. 3, 4, and 5, the fluid passage 46 extends as a three dimensional flow movement through one embodiment of the valve cage 30. As shown, initially, a fluid flow at the interior chamber 37 enters each of the inlet apertures 42. For convenience in the illustration and description, the three dimensional flow path through one of the inlet apertures (identified as inlet aperture 60), to multiple outlet apertures 44 is described.

As the example illustrates, fluid enters the inlet aperture 60 and proceeds through the expansion zone 52 and extends axially upwardly as well as axially downwardly through the fluid passage 46 and into the adjacent plenums 48. After being split into two initial axial directions, the fluid flow now extends into multiple radial and circumferential flow directions within the adjacent plenums 48.

Next, the fluid flow encounters the contraction zone 54 of the respective outlet apertures 44. For example, each of the fluid flow paths in the plenums 48 encounter the contraction zones 54 such that the fluid flow streams respectively axially upward and axially downward and out the outlet apertures 46.

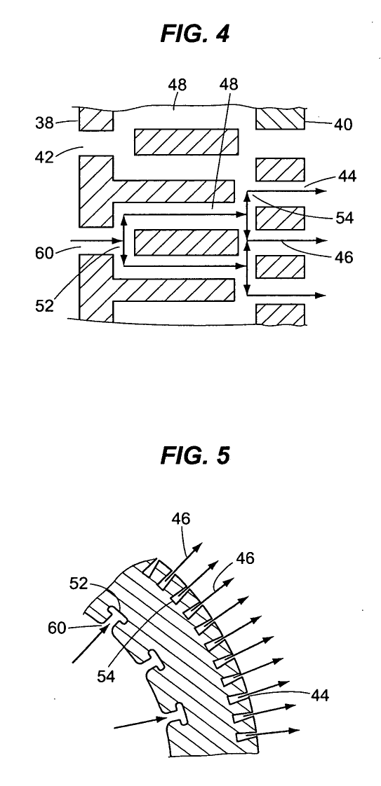

It will be appreciated that this is only one example of the fluid passage 46 from the inlet apertures 42 passing through to the outlet apertures 46. In reality, the fluid passage 46 may be distributed circumferentially through multiple outlet apertures 44. For example, FIG. 5 illustrates that within the valve cage 30, the fluid flow is distributed circumferentially through and finally out multiple outlet apertures 44.

Turning to FIG. 6, an example of a tortuous path 47 is illustrated. As the example illustrates, fluid enters one of the inlet apertures 42 and radially proceeds along the tortuous path 47. The fluid then encounters a first bend 47A which forces the fluid in a direction having at least a circumferential component. The fluid may proceed through a number of bends 47B, 47C, 47D until it encounters a split 47E. It will be appreciated that in the illustrated embodiment, each of the bends 47A-47D in combination form an expansion zone, as the cross sectional area of the tortuous path 47 increases as it extends from the inner surface 38. It will be noted, however, that the tortuous path 47 may have multiple expansion and/or contraction zones throughout the path 47, as is described above.

After being split into two circumferential directions, the tortuous path 47 now extends into multiple radial and circumferential flow directions within the tortuous paths 47F and 47G. Each of the tortuous paths 47F, 47G having multiple bends as previously described. Finally, the fluid flow extends out the outlet apertures 44.

The above described valve cage 30 contains a plurality of multidirectional fluid passages 46. To create a fluid passage 46 through the valve cage 30, material voids may be formed within the valve cage 30 housing by removing material (e.g., through drilling, cutting, etc.), or the valve cage 30 may be formed around voids creating the fluid passages 46, by adding material (e.g., through molding, or similar process).

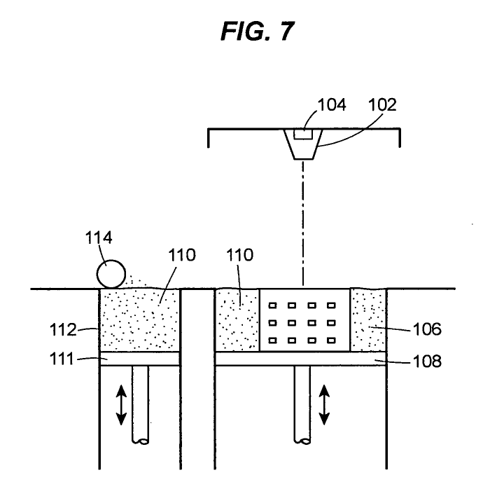

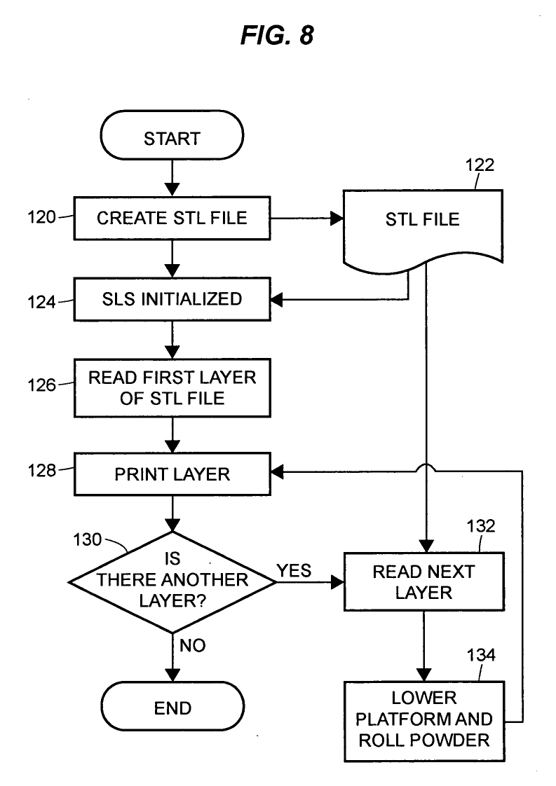

One example of a manufacturing process which may be suitable for making the disclosed valve cage 30 is known as Selective Laser Sintering (SLS). As illustrated in FIG. 7, a SLS printing apparatus 100 may comprise a print head 102 containing an optical laser 104 and being movable in the x and y directions over a printing surface as will be described below. The optical laser 104 may emit radiation, which typically lies between wavelengths of about 2000 nm on the visible-light side and about 300 nm on the x-ray side.

A powder bed 106 is supported by a build platform 108 and is located below the print head 102 so as to intercept the emitted radiation from the optical laser 104. The powder bed 106 may be capable of translation in the z direction as illustrated and is filled with an SLS powdered material 110 which is spread from a powder tank 112 across the build platform 108 by a precision roller 114. The powder tank 112 may be raised or lowered by a powder piston 111. The SLS powdered material 110 may be any material developed for use in SLS systems. While there are many SLS powdered materials available with a wide variety of wavelength sensitivities and physical properties, one example of the SLS powdered material 110 is Accura™ LaserForm™ ST-200 available from 3D Systems, Inc. Valencia, Calif.

A typical operation of the manufacture of the valve cage 30 utilizing the SLS printing apparatus 100 is set forth in the flow diagram illustrated in FIG. 7. At a block 120, an operator creates a stereolithography file (STL file) 122. The STL file 122 is a standard format stereolithography representation of the valve cage 30, and may be created by a number of commercially available CAD systems for three dimensional prototype design, such as AutoCAD® available from Autodesk, Inc., of San Rafael, Calif. The STL file 122 is a thin layer representation of the three-dimensional valve cage 30, and typically consists of five to ten layers per millimeter. While an STL file is a standard file format for stereolithography, those of ordinary skill in the art will recognize that the format is merely exemplary and may be any file format capable of representing a three-dimensional object.

Once the STL file 122 has been created, the file is uploaded to the SLS printing apparatus 100. The SLS printing apparatus 100 then initializes itself, at a block 124, by applying a thin layer of SLS powdered material 110 over the build platform 108 utilizing the roller 114. The SLS printing apparatus 100 then reads the first layer of the STL file 122 at a block 126 to print the first layer.

Once the layer is read, at a block 128, the print head 102 and the optical laser 104 print the layer by translating the optical laser 102 over the powder bed 106, in the x and y directions, and activating the laser 102 to solidify the SLS powdered material 110 as necessary. In this fashion, a thin layer of solid metal is deposited on the build platform 108. Once the entire layer is printed, at a block 130, the SLS printing apparatus 100 determines if the STL file 122 contains another layer to be printed.

If it is determined there is another layer to be printed, the next layer of the STL file 122 is read at a block 132. At a block 134, the SLS printing apparatus 100 determines the appropriate distance the build platform 108 should be translated to correctly correspond to the layer thickness, and lowers the platform 108 accordingly. Also at the block 134, the SLS printing apparatus 100 applies another thin layer of SLS powdered material 110 over the lowered build platform 108. The next layer is then printed at the block 128, and the process repeats until the block 130 determines there are no more layers which need to be printed, at which point, the object is complete and may be removed from the SLS printing apparatus 300.

The foregoing description is not intended to limit the scope of the invention to the precise form disclosed. It is contemplated that various changes and modifications may be made by those skilled in the art without departing from the spirit and scope of the invention.

1. A valve cage for use in a control valve, the valve cage comprising:
a sidewall surrounding a bore, the sidewall having an inner surface and an outer surface, the sidewall being contiguously formed;
a plurality of fluid inlets defined on the inner surface of the sidewall;
a plurality of fluid outlets defined on the outer surface of the sidewall; and
a plurality of multidirectional fluid passageways, each of the fluid passageways extending between one of the plurality of fluid inlets and a corresponding one of the plurality of fluid outlets, each fluid passageway defining a multidirectional flow path between the inner surface of the sidewall and the outer surface of the sidewall.

2. The valve cage of claim 1, wherein a first one of the fluid passageways intersects a second one of the fluid passageways.

3. The valve cage of claim 1, wherein at least one of the fluid passageways has a variable cross section.

4. The valve cage of claim 1, wherein each of the fluid passageways includes at least one of an expansion zone and a contraction zone.

5. The valve cage of claim 1, wherein each of the fluid passageways includes both an expansion zone and a contraction zone, and a transition section between the expansion zone and the contraction zone.

6. The valve cage of claim 1, wherein at least some of the fluid inlets have a first cross sectional area and at least some of the fluid outlets have a second cross sectional area different than the first cross sectional area.

7. The valve cage of claim 1, wherein each of the fluid passageways is formed so as to direct the flow path in a first direction having a radial component with respect to a center axis of the valve cage and a second direction having an axial component with respect to the center axis of the valve cage.

8. The valve cage of claim 1, wherein each of the fluid passageways is formed so as to direct the flow path in at least one of a first direction having a radial component with respect to a center axis of the valve cage, a second direction having an axial component with respect to the center axis of the valve cage, and a third direction having a circumferential component with respect to the center axis of the valve cage.

9. The valve cage of claim 1, wherein the sidewall is formed by selective laser sintering.

10. A valve cage for fluid pressure reduction, the valve cage comprising:
a cylindrical housing having an interior surface, an exterior surface, and enclosing an interior chamber, the housing being integrally formed of a single piece of material;
a plurality of first apertures arranged on the interior surface of the housing;
a plurality of second apertures arranged on the exterior surface of the housing; and
a plurality of fluid passages, each of the fluid passages extending between one of the plurality of first apertures and at least one of the plurality of second apertures, each fluid passage defining a tortuous fluid flow path between the interior and the exterior surface of the housing.

11. The valve cage of claim 10, wherein at least one of the fluid passages has a variable cross section.

12. The valve cage of claim 10, wherein at least one of the fluid passages includes at least one of an enlarged region and a narrowed region.

13. The valve cage of claim 10, wherein at least one of the fluid passages includes an enlarged region, a narrowed region, and a transition region extending between the enlarged region and the narrowed region.

14. The valve cage of claim 10, wherein the tortuous fluid flow path is formed in a first direction having a radial component with respect to a central axis of the valve cage and a second direction having an axial component with respect to the central axis of the valve cage.

15. The valve cage of claim 10, wherein the housing is formed by a selective laser sintering manufacturing process.

16. A valve cage comprising:
a housing having an interior surface, an exterior surface, and an interior chamber, the housing being unitarily formed in a single body using a selective laser sintering process;
a plurality of fluid inlets defined on the interior surface of the housing;
a plurality of fluid outlets defined on the exterior surface of the housing; and
a plurality of fluid pathways extending between one of the plurality of fluid inlets and at least one of the plurality of fluid outlets, the fluid pathways being defined by one or more directional changes.

17. The valve cage of claim 16, wherein at least one of the fluid passages has a variable cross section.

18. The valve cage of claim 16, wherein at least one of the fluid pathways is formed in a first direction and a second direction, the first direction having at least one of a radial component, a circumferential component, and an axial component with respect to a longitudinal axis of the valve cage, the second direction having at least one of an axial component, a circumferential component, and a radial component with respect to the longitudinal axis of the valve cage, the first and second directions being different.

19. The valve cage of claim 16, wherein at least one of the fluid pathways includes at least one of an expansion zone and a contraction zone.

20. The valve cage of claim 16, wherein each of the fluid pathways includes an expansion zone, a contraction zone, a transition extending between the expansion zone and the contraction zone.

21. The valve cage of claim 16, wherein each of the fluid pathways is formed in a first direction having a radial component with respect to a central axis of the valve cage and a second direction having an axial component with respect to the central axis of the valve cage.

22. A control valve comprising:
a valve body having an inlet, an outlet, and a flow passage extending between the inlet and the outlet;
a seat ring mounted in the flow passage;
a valve plug shiftably mounted within the valve body for movement between a first position and a second position, the valve plug cooperating with the seat ring to close the flow passage when the valve plug is in the first position;
a valve plug actuator for moving the valve plug between the first position and the second position; and
a tubular valve cage disposed within the valve body and having an end sized to be mounted to the seat ring, the valve cage comprising:
a sidewall having an inner surface and an outer surface and surrounding a bore sized to receive the valve plug, the sidewall being contiguously formed;
a plurality of first apertures defined in the inner surface of the sidewall;
a plurality of second apertures defined in the outer surface of the sidewall; and
a plurality of fluid passages extending between each of the first apertures and at least one of the second apertures, each one of the fluid passages defining a multidirectional flow path between the inner surface and the outer surface of the sidewall, wherein at least one of the fluid passages is disposed in the flow passage when the valve plug is in the second position.

23. The control valve of claim 22, wherein at least one of the multidirectional fluid passages includes at least one of an expansion zone and a contraction zone.

24. The control valve of claim 22, wherein the plurality of first apertures cooperate to define an area, and wherein a progressively greater portion of the area is disposed in the flow passage in response to moving the valve plug away from the first position.

25. The control valve of claim 22, wherein the tubular valve cage is formed by selective laser sintering.
